(19) United States
(12) Patent Application Publication
(10) Pub. No.: US 2009/0033961 A1
(43) Pub. Date: Feb. 5, 2009

(54) IMAGE PROCESSING METHOD AND APPARATUS, AND CPU-READABLE RECORDING MEDIUM

(75) Inventor: Kiyomi TAMAGAWA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/179,980

(22) Filed: Jul. 25, 2008

(30) Foreign Application Priority Data
Jul. 30, 2007 (JP) 2007-197697

(51) Int. Cl. G06F 15/00

(52) U.S. Cl. 358/1.9

(57) ABSTRACT

A device CMYKW 8-bit signal supplied to an image output device is controlled so that the total amount of color materials per unit area will not exceed an upper limit therefor. Until a provisional total amount of color materials reaches a value 765, a device CMYKW 8-bit signal is output with the white color material being kept at a maximum gradation level 255. When the provisional total amount is in the range between the values 765 and 1020, the amount of the white color material is reduced from the maximum gradation level to 0 to keep the total amount be the value 765. When the provisional total amount is in the range between the values 1020 and 1275, a UCR process is performed while the amount of the white color material is kept at 0. Consequently, the total amount is kept 765 of 300% or lower all the time.

### BACKGROUND OF THE INVENTION

1. Field of the Invention

The present invention relates to an image processing method and apparatus applicable to an image output device for forming, on a base such as a sheet or the like, a color image of process color materials {C (cyan), M (magenta), Y (yellow), and K (black)} and a base color material, e.g., W (white), whose color is determined by the total amount of color materials that are applied per unit area (including per pixel), and a CPU-readable recording medium storing therein a program for carrying out such an image processing method.

2. Description of the Related Art

Electrophotographic printers which employ toners as color materials, and image output devices (image forming devices) such as ink jet printers or the like and printing presses which employ inks as color materials operate to form an image on a sheet (a support or a recording medium) of paper (printing paper) by applying color materials per unit area.

The colors of the image formed on the sheet are affected by the background color of the sheet. There has been proposed the technology of an ink jet printer for forming a desired color image on a yellowish white sheet such as a recycled sheet of paper, a postal card, or the like while preventing the color image from being affected by the yellowish white which is the background color of the sheet (see Japanese Laid-Open Patent Publication No. 2002-038063).

According to the proposed technology, a white ink is applied from an ink set to a yellowish white sheet and then dried to turn the background color of the yellowish white sheet into white. Thereafter, process inks including yellow, magenta, light magenta, cyan, light cyan, black, etc. are applied from the ink set additively to form a color image on the sheet.

In reality, the total amount of color materials that can be applied to or added on the sheet per unit area is fixed for each image output device. The range of C, M, Y, K values that can be adopted in an image output device depends on the total amount of color materials used in the image output device.

For example, as shown in FIG. 5A of the accompanying drawings, if each of the four color materials C, M, Y, K can be applied up to 100% on a sheet S per unit area, then the upper limit of the total amount of color materials is 400% {(C, M, Y, K)=(100, 100, 100, 100)}.

If the total amount of color materials has an upper limit of 300%, then, as shown in FIG. 5B, each of the four color materials C, M, Y, K can be applied up to 75% on a sheet S. In this case, although not shown, if the color material C is applied by 100%, then the sum of the remaining three color materials M, Y, K is limited to 200%.

If color materials are added in excess of a total amount of 100% and tend to droop, as shown in FIG. 5C, then the total amount of color materials is limited to an upper limit of 100%.

If four color materials C, M, Y, K can be applied in a total amount of up to 250% to a sheet S, i.e., if the total amount of color materials has an upper limit of 250%, and the color material C is applied by 100%, as shown in FIG. 5D, then the remaining three color materials M, Y, K can be applied each by 50%.

In the description of the present specification, the amount of a color material is expressed on percentage % in a range from 0% to 100% which corresponds to a gradation range of 8-bit image data from a gradation level 0 to 255. Specifically, the maximum gradation level 255 corresponds to 100%, the minimum gradation level 0 corresponds to 0%, and the intermediate gradation level 127 corresponds to 50%. The percentage % may be considered to be halftone dot %. If the image data represent a halftone image, then a dot provided as each halftone dot is considered to be a unit area.

When a white ink is applied to the entire surface of an image area on a sheet as disclosed in Japanese Laid-Open Patent Publication No. 2002-038063, since the total amount of inks that can be applied to the sheet is finite in reality, only a limited amount of the inks can further be applied, tending to result in image formation problems that excess inks droop and cannot be fixed in place.

Nevertheless, Japanese Laid-Open Patent Publication No. 2002-038063 does not refer to anything addressed to the above problems.

### SUMMARY OF THE INVENTION

It is an object of the present invention to provide an image processing method and apparatus for preventing image formation problems that color materials droop and cannot be fixed in place, in a process of forming, on a base, a color image with a background color material and process color materials, the color image being determined by the total amount of color materials applied per unit area, and to provide a CPU-readable recording medium.

According to the present invention, there is provided an image processing method applicable to an image output device for forming a color image on a base with a background color material and process color materials, the color image having colors determined by the total amount of the color materials that are applied per unit area, the image processing method comprising a process of determining a provisional total amount of color materials by adding an amount of the background color material represented by a certain value to the amounts of the process color materials per unit area which are represented by a device signal supplied to the image output device, and a total-amount-of-color-material adjusting process of reducing the provisional total amount of color materials so that the total amount of color materials will not exceed a total-amount-of-color-material upper limit for the image output device.

According to the above image processing method, the provisional total amount of color materials is determined by adding an amount of the background color material that is represented by a certain value to the amounts of the process color materials per unit area that are represented by the device signal supplied to the image output device, and the provisional total amount of color materials is reduced so that the total amount of color materials does not exceed the total-amount-of-color-material upper limit for the image output device. Therefore, the total amount of color materials is kept below the total-amount-of-color-material upper limit.

If the determined provisional total amount of color materials does not exceed the total-amount-of-color-material upper limit for the image output device, the total-amount-of-color-material adjusting process determines the provisional total amount of color materials as a total amount of color materials. On the other hand, if the determined provisional total amount of color materials exceeds the total-amount-of-color-material upper limit for the image output device by an excessive value, the total-amount-of-color-material adjusting process determines a value which is produced by subtracting an amount of the background color material that corresponds to the excessive value from the provisional total amount of color materials, as the total amount of color materials. Therefore, the total amount of color materials can be kept below the total-amount-of-color-material upper limit through simple calculations.

If the determined provisional total amount of color materials exceeds the total-amount-of-color-material upper limit for the image output device by an excessive value, and the excessive value is greater than the certain value of the background color material, the total-amount-of-color-material adjusting process determines a value produced by reducing the amounts of process color materials which are represented by the device signal according to a UCR process, as the total amount of color materials. Therefore, the total amount of color materials can be kept below the total-amount-of-color-material upper limit as much as possible.

The background color material comprises a white color material, and the process color materials comprise C, M, Y, and K color materials. The base preferably comprises a transparent base such as a transparent sheet or the like.

According to the present invention, there is also provided an image processing apparatus applicable to an image output device for forming a color image on a base with a background color material and process color materials, the color image having colors determined by the total amount of the color materials that are applied per unit area, the image processing apparatus comprising means for determining a provisional total amount of color materials by adding an amount of the background color material that is represented by a predetermined value to the amounts of the process color materials per unit area that are represented by a device signal supplied to the image output device, and total-amount-of-color-material adjusting means for reducing the provisional total amount of color materials so that the total amount of color materials does not exceed a total-amount-of-color-material upper limit for the image output device.

According to the above image processing apparatus, the provisional total amount of color materials is determined by adding an amount of the background color material that is represented by a predetermined value to the amounts of the process color materials per unit area that are represented by the device signal supplied to the image output device, and the provisional total amount of color materials is reduced so that the total amount of color materials does not exceed the total-amount-of-color-material upper limit for the image output device. Therefore, the total amount of color materials is kept below the total-amount-of-color-material upper limit.

According to the present invention, there is further provided a CPU-readable recording medium storing therein a program executable by a CPU and applicable to an image output device for forming a color image on a base with a background color material and process color materials, the color image having colors determined by the total amount of the color materials that are applied per unit area, the program enabling the CPU to perform a step of determining a provisional total amount of color materials by adding an amount of the background color material that is represented by a predetermined value to the amounts of the process color materials per unit area that are represented by a device signal supplied to the image output device, and a total-amount-of-color-material adjusting step of reducing the provisional total amount of color materials so that the total amount of color materials does not exceed a total-amount-of-color-material upper limit for the image output device.

If the image comprises a halftone dot image, then the unit area corresponds to a halftone dot. If the image is formed by pixels, then the unit area corresponds to a pixel.

According to the present invention, the device signal supplied to the image output device is controlled so that the total amount of color materials per unit area does not exceed an upper limit therefor per unit area specific to the image output device.

According to the present invention, furthermore, when the color image is formed on the base using the background color material and the process color materials and whose colors are determined by the total amount of color materials that are applied per unit area, the color image is free of image formation problems such as ink drooping, ink fixation failures, etc.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of an image reproducing system to which an image processing method and apparatus according to an embodiment of the present invention are applied;

FIG. 2 is a block diagram of function realizing means provided by a CPU of the image reproducing system;

FIG. 3 is a flowchart of a program representing a color material adjusting sequence executed by the CPU;

FIG. 4 is a graph illustrative of a process of adjusting a total amount of color materials according to the embodiment of the present invention;

FIG. 5A is a diagram showing that the total amount of color materials per unit area has an upper limit of 400%;

FIG. 5B is a diagram showing that the total amount of color materials per unit area has an upper limit of 300%;

FIG. 5C is a diagram showing the manner in which inks droop when the total amount of color materials per unit area has an upper limit of 100%; and

FIG. 5D is a diagram showing that the total amount of color materials per unit area has an upper limit of 250%.

### DESCRIPTION OF THE PREFERRED EMBODIMENT

An embodiment of the present invention will be described below with reference to the drawings.

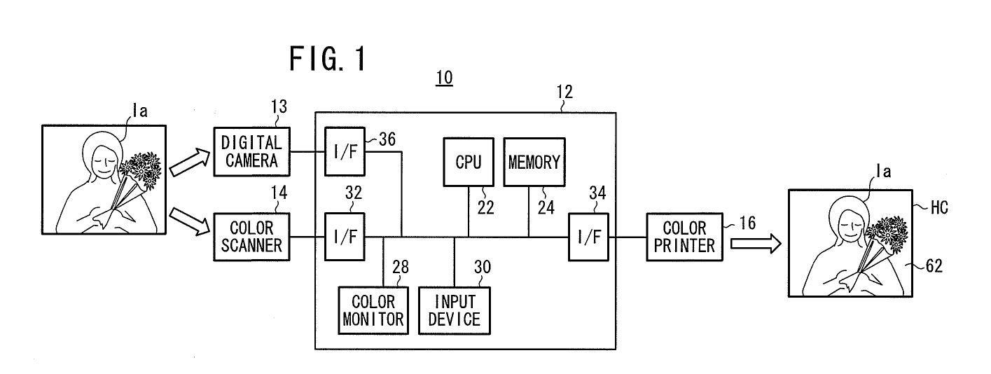

FIG. 1 shows in block form an image reproducing system 10 to which an image processing method and apparatus according to an embodiment of the present invention are applied.

As shown in FIG. 1, the image reproducing system 10 basically comprises a personal computer 12, image input devices (image input apparatus) such as a digital camera (color digital camera) 13 and a color scanner 14 which are connected to the personal computer 12, and an image output device (image output apparatus, image forming apparatus) such as a color printer 16. The color printer 16 may comprise an ink jet printer or an electrophotographic printer, for example.

The digital camera 13 captures a color image Ia of a subject and sends a device RGB 8-bit signal representing the color image Ia through an interface 36 to the personal computer 12. The device RGB 8-bit signal refers to 8-bit device signals representing images in three colors R, G, B.

The color scanner 14 reads a color image Ia from a color original such as a color reversal film or the like and sends a device CMYK 8-bit signal representing the color image Ia through an interface 32 to the personal computer 12. The device CMYK 8-bit signal refers to 8-bit device signals representing images in four colors C, M, Y, K.

The personal computer 12 includes a CPU 22, a memory 24, a color monitor 28, and an input device 30 including a keyboard, a mouse, etc. which are connected to each other by a bus. The personal computer 12 also includes the interface 36 for receiving the device RGB 8-bit signal from the digital camera 13, the interface 32 for receiving the device CMYK 8-bit signal from the color scanner 14, and an interface 34 for supplying a device CMYKW 8-bit signal to the color printer 16. The device CMYKW 8-bit signal refers to 8-bit device signals representing images in five colors C, M, Y, K, W (white).

The memory 24 comprises a DRAM (main memory) and a flash memory (rewritable nonvolatile memory). The CPU 22 operates as various function realizing means when it executes programs stored in the memory 24 based on various input signals applied to the CPU 22.

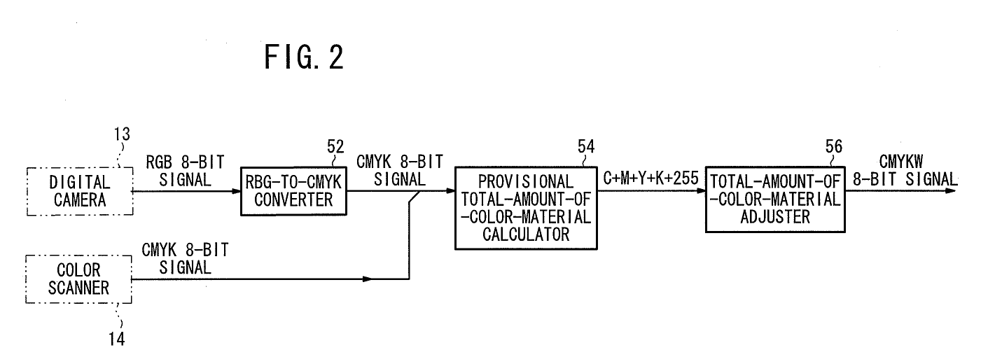

As shown in FIG. 2, the CPU 22 functions as an RGB-to-CMYK converter 52, a provisional total-amount-of-color-material calculator 54, and a total-amount-of-color-material adjuster 56 as the function realizing means.

The RGB-to-CMYK converter 52 converts the device RGB 8-bit signal supplied from the digital camera 13 through the interface 36 into a device CMYK 8-bit signal.

The provisional total-amount-of-color-material calculator 54 calculates a provisional total amount of color materials TOTAL_VALUE=C+M+Y+K+255 by adding a certain amount (maximum gradation level 255 (=W) of 8-bit image data in the present embodiment) of a background color material (W (white) in the present embodiment) to the amounts of color materials corresponding to either the device CMYK 8-bit signal from the RGB-to-CMYK converter 52 or the device CMYK 8-bit signal from the color scanner 14.

The total-amount-of-color-material adjuster 56 checks the calculated provisional total amount of color materials TOTAL_VALUE=C+M+Y+K+255 to see if it does not exceed a total-amount-of-color-material upper limit INK_LIMIT (which represents, in the present embodiment, a value of 765 (300% in terms of halftone dot %) that is three times the maximum gradation level 255 of each color material) which can be realized (i.e., which can be formed or which can be superimposed without the inks drooping) by the color printer 16. If the provisional total amount of color materials TOTAL_VALUE=C+M+Y+K+255 exceeds the total-amount-of-color-material upper limit INK_LIMIT, then the total-amount-of-color-material adjuster 56 reduces the provisional total amount of color materials TOTAL_VALUE=C+M+Y+K+255 according to a predetermined equation so that it does not exceed the total-amount-of-color-material upper limit INK_LIMIT. The total-amount-of-color-material adjuster 56 outputs a device CMYKW 8-bit signal, which represents the adjusted total amount of color materials, to the color printer 16.

The color printer 16 outputs a hard copy HC comprising a transparent base 62 such as a transparent sheet or the like with a color image Ib thereon which is reproduced from the color image Ia, based on the device CMYKW 8-bit signal, which represents the adjusted total amount of color materials, supplied from the personal computer 12 through the interface 34. In the present embodiment, the color printer 16 uses inks in five colors C, M, Y, K, W and is capable of forming a color image Ib based on the device CMYKW 8-bit signal on the transparent base 62 serving as a print sheet without image formation problems such as ink drooping, ink fixation failures, etc. in a range up to the upper limit of the device CMYKW 8-bit signal, i.e., the total-amount-of-color-material upper limit INK_LIMIT of 765 (300% in terms of halftone dot %).

In those areas of the transparent base 62 where the color image Ib is not formed, there is printed a W (white) image (solid image) of the W color material at the maximum gradation level 255 thereof, as the background color.

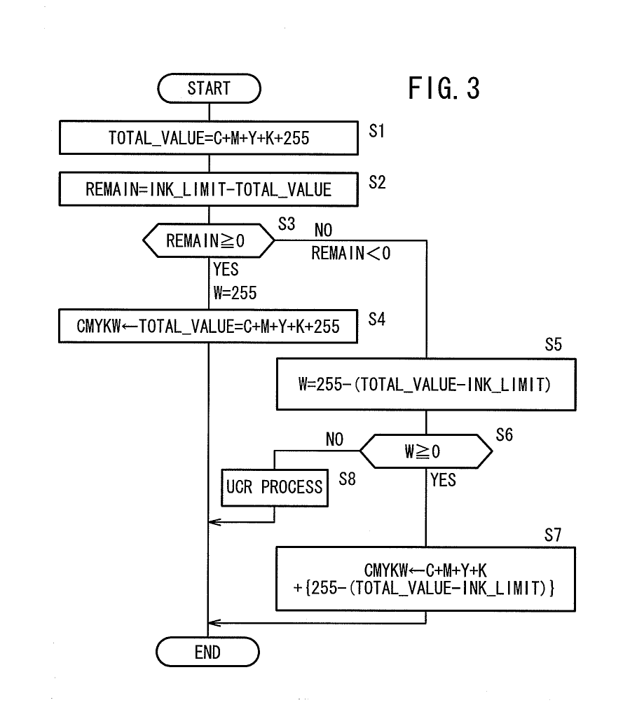

The image reproducing system 10 according to the present embodiment is basically constructed and operates as described above. Operation of the image reproducing system 10 which is carried out by the CPU 22 which functions as the function realizing means (function realizers) shown in FIG. 2 will be described below with reference to FIG. 3 which shows a color material adjusting sequence performed by the CPU 22.

In step S1, the provisional total-amount-of-color-material calculator 54 calculates a provisional total amount of color materials TOTAL_VALUE by adding the amount of the W color material, which is the background color material, represented by the maximum gradation level 255, to the amounts of the color materials C, M, Y, K, as the process color materials, of the device CMYK 8-bit signal supplied from the RGB-to-CMYK converter 52 or the color scanner 14, according to the following equation (1):

TOTAL_VALUE=C+M+Y+K+255 (1)

In step S2, the total-amount-of-color-material adjuster 56 determines a marginal amount of color materials REMAIN as a parameter by subtracting the provisional total amount of color materials TOTAL_VALUE from the total-amount-of-color-material upper limit INK_LIMIT, according to the following equation (2):

REMAIN=INK_LIMIT−TOTAL_VALUE (2)

In step S3, the total-amount-of-color-material adjuster 56 judges whether the marginal amount of color materials REMAIN is of a value that actually provides a margin with respect to the total-amount-of-color-material upper limit INK_LIMIT (REMAIN≧0) or not, i.e., whether the marginal amount of color materials REMAIN is of a margin-less value or not.

If the marginal amount of color materials REMAIN is of a value that actually provides a margin with respect to the total-amount-of-color-material upper limit INK_LIMIT=765 (REMAIN≧0), or stated otherwise, if the provisional total amount of color materials TOTAL_VALUE is of a value less than 765, then since it is known that the color printer 16 is capable of forming a color image free of ink drooping on the transparent base 62, the total-amount-of-color-material adjuster 56 outputs a device CMYKW 8-bit signal representing the provisional total amount of color materials TOTAL_VALUE as the total amount of color materials to the color printer 16, in step S4.

However, if the marginal amount of color materials REMAIN is of a margin-less value with respect to the total-amount-of-color-material upper limit INK_LIMIT=765 (REMAIN<0), or stated otherwise, the provisional total amount of color materials TOTAL_VALUE is of a value equal to or greater than 765, since it is highly likely to cause ink drooping on the transparent base 62 in step S5, the total-amount-of-color-material adjuster 56 determines an amount (gradation level) of the W color material {the amount of the W color material (the value of the W color material) is also denoted by W} as a value produced by subtracting a value (TOTAL_VALUE−INK_LIMIT)=−REMAIN>0 from a constant value (the maximum gradation level 255 of the W color material in the present embodiment) according to the following equation (3):

$$C + M + Y + K + W = C + M + Y + K + \{ 255 - ( TOTAL\_VALUE - INK\_LIMIT ) \} = C + M + Y + K + 255 + REMAIN ( REMAIN has a negative value ) \qquad ( 3 )$$

In step S6, the total-amount-of-color-material adjuster 56 judges whether or not the amount (gradation level) of the W color material W=255−(TOTAL_VALUE−INK_LIMIT) is of a value which is equal to or greater than 0 (W≧0).

If the value of the amount (gradation level) of the W color material is W≧0, then in step S7 the total-amount-of-color-material adjuster 56 outputs a device CMYKW 8-bit signal representing C+M+Y+K+W=C+M+Y+K+{255−(TOTAL_VALUE−INK_LIMIT)} as the total amount of color materials. If the value of the amount (gradation level) of the W color material is W<0, then in step S8 the total-amount-of-color-material adjuster 56 sets the amount W of the W color material to W=0, and outputs a device CMYK 8-bit signal representing the total amount of color materials which is produced by reducing the amounts of process color materials C, M, Y, K according to a UCR (Under Color Removal) process. The UCR process is a known process whereby the added amounts of ink in C, M, Y in the dark neutral areas are replaced with an amount of ink in K.

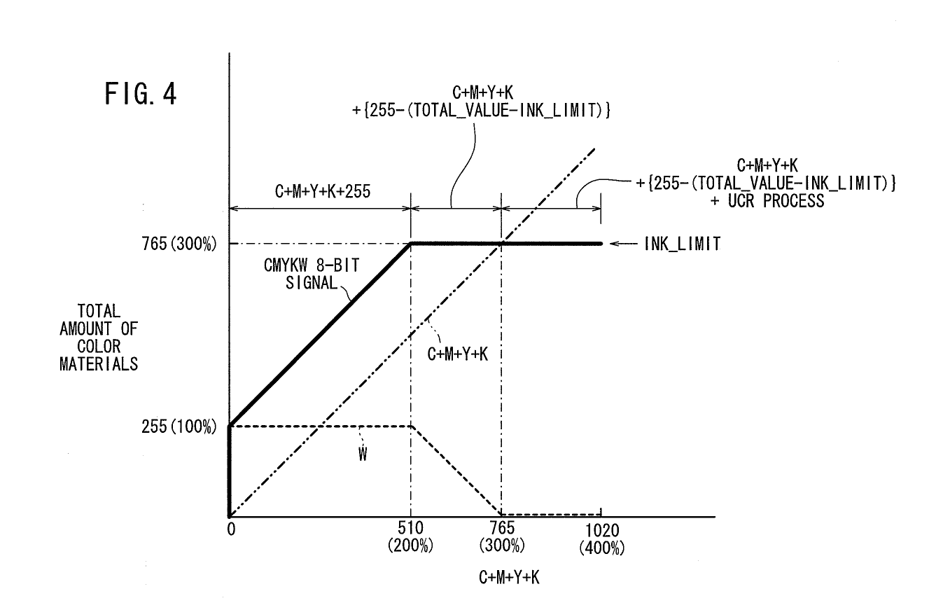

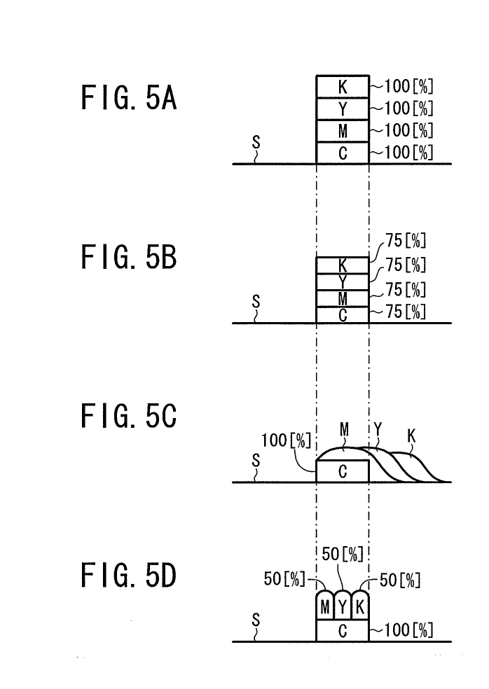

FIG. 4 is a graph illustrative of the color material adjusting sequence shown in FIG. 3.

In FIG. 4, the solid-line characteristic curve represents the device CMKY 8-bit signal supplied to the color printer 16 after adjustment of the total amount of color materials determined by the total-amount-of-color-material adjuster 56. According to the solid-line characteristic curve, until the amount of process color materials=C+M+Y+K represented by the device CMKY 8-bit signal that is supplied to the provisional total-amount-of-color-material calculator 54 reaches a value 510, the total-amount-of-color-material adjuster 56 outputs the device CMYKW 8-bit signal with the W color material being kept at the maximum gradation level of 255, thereby keeping it below the value 765 (300%) in step S4. When the amount of color materials=C+M+Y+K is in the range between the values 510 and 765, the total-amount-of-color-material adjuster 56 reduces the amount of the W color material represented by the device CMYKW 8-bit signal from the maximum gradation level of 255 to 0 until the amount of color materials C+M+Y+K+255 represented by the device CMYKW 8-bit signal reaches the value 765, thereby keeping the device CMYKW 8-bit signal below the value 765 (300%) in step S7.

When the amount of color materials=C+M+Y+K represented by the device CMYK 8-bit signal is in the range between the values 765 and 1020, the total-amount-of-color-material adjuster 56 performs the UCR process while the gradation level of the W color material is remaining to be 0, thereby keeping the device CMYKW 8-bit signal at the value 765 (300%) in step S8. At this time, no W color material is added or applied to each unit area on the transparent base 62 which has been processed by the UCR process.

In this manner, the personal computer 12 supplies the color printer 16 at all times with the device CMYKW 8-bit signal which represents the total amount of color materials C+M+Y+K+W which is kept within the total-amount-of-color-material upper limit INK_LIMIT=765 (300%) where the color printer 16 does not cause ink drooping.

Stated otherwise, until the amount of color materials=C+M+Y+K reaches the value 510, the total-amount-of-color-material adjuster 56 outputs the device CMYKW 8-bit signal with the W color material being kept at the maximum gradation level 255 (100%). When the amount of color materials=C+M+Y+K is in the range between the values 510 and 765, the total-amount-of-color-material adjuster 56 reduces the amount of the W color material from the maximum gradation level 255 to 0 until the amount of color materials C+M+Y+K represented by the device CMYKW 8-bit signal reaches the value 765. When the amount of color materials=C+M+Y+K is in the range between the values 765 and 1020, the total-amount-of-color-material adjuster 56 performs the UCR process while the W color material is being kept at the gradation level 0. As a result, the device CMYKW 8-bit signal is kept within 300% at any time, so that the color printer 16 can output the hard copy HC having the color image Ib which is free of ink drooping and other image formation failures.

In those areas of the transparent base 62 where the color image Ib is not formed, there is applied an amount of ink which corresponds to the amount of the W color material represented by the constant value (maximum gradation level) 255 as the background color. In unit areas on the color image Ib whose provisional total amount of color materials TOTAL_VALUE=C+M+Y+K+255 exceeds the value 765 (300%), the W color material is not applied at all, but the color image Ib is formed of only the C, M, Y, K color materials as the process color materials.

According to the present embodiment, as described above, the image processing method and apparatus are applied to the color printer (image output device) 16 which forms on the transparent base 62 the color image Ib that is formed of the W color material (background color material) and the C, M, Y, K color materials (process color materials) and whose colors are determined by the total amount of color materials C, M, Y, K, W that are added per unit area. The provisional total-amount-of-color-material calculator 54 (provisional total-amount-of-color-material calculating process, provisional total-amount-of-color-material calculating step) determines the provisional total amount of color materials TOTAL_VALUE by adding the constant amount W of the W color material=255 (maximum gradation level) to the amounts of color materials C, M, Y, K represented by the device CMYK 8-bit signal for each unit area that is supplied to the color printer 16. Then, the total-amount-of-color-material adjuster 56 (total-amount-of-color-material adjusting process, total-amount-of-color-material adjusting step) reduces the provisional total amount of color materials TOTAL_VALUE so that the determined provisional total amount of color materials TOTAL_VALUE will not exceeds the total-amount-of-color-material upper limit INK_LIMIT of 765 (255×3)=300% for the color printer 16. Therefore, the total amount of color materials C, M, Y, K, W remains to be the total-amount-of-color-material upper limit INK_LIMIT of 765 (300%) or lower.

According to the present embodiment, briefly stated, the device CMYKW 8-bit signal supplied to the color printer 16 as the image output device is controlled so that the total amount of color materials per unit area will not exceed the total-amount-of-color-material upper limit INK_LIMIT. Therefore, when the color image Ib is formed on the transparent base 62 using the background color material (the white color material in the present embodiment) and the process color materials (the C, M, Y, K color materials in the present embodiment, which may include light cyan, light magenta, etc.) and has colors determined by the total amount of color materials C, M, Y, K, W that are applied per unit area, the color image Ib is free of image formation problems such as ink drooping, ink fixation failures, etc.

Although a certain preferred embodiment of the present invention has been shown and described in detail, it should be understood that various changes and modifications may be made therein without departing from the scope of the appended claims.

What is claimed is:

1. An image processing method applicable to an image output device for forming on a base a color image with a background color material and process color materials, said color image having colors determined by a total amount of the color materials that are applied per unit area, said image processing method comprising:
a process of determining a provisional total amount of color materials by adding an amount of said background color material represented by a certain value to the amounts of said process color materials per unit area which are represented by a device signal supplied to said image output device; and
a total-amount-of-color-material adjusting process of reducing said provisional total amount of color materials so that the total amount of color materials is equal to or lower than a total-amount-of-color-material upper limit for said image output device.

2. An image processing method according to claim 1, wherein if the determined provisional total amount of color materials does not exceed the total-amount-of-color-material upper limit for said image output device, said total-amount-of-color-material adjusting process determines said provisional total amount of color materials as a total amount of color materials, and if the determined provisional total amount of color materials exceeds the total-amount-of-color-material upper limit for said image output device by an excessive value, said total-amount-of-color-material adjusting process determines a value which is produced by subtracting an amount of said background color material that corresponds to said excessive value from said provisional total amount of color materials, as said total amount of color materials.

3. An image processing method according to claim 2, wherein if the determined provisional total amount of color materials exceeds the total-amount-of-color-material upper limit for said image output device by an excessive value, and said excessive value is greater than the value produced by subtracting said amount of said background color material represented by said certain value, said total-amount-of-color-material adjusting process determines a value produced by reducing the amounts of said process color materials which are represented by said device signal according to a UCR process, as said total amount of color materials.

4. An image processing method according to claim 1, wherein said base comprises a transparent base, and said image output device comprises an ink jet printer or an electrophotographic printer.

5. An image processing method according to claim 1, wherein said background color material comprises a white color material, and said process color materials comprise C, M, Y, and K color materials.

6. An image processing apparatus applicable to an image output device for forming a color image on a base with a background color material and process color materials, said color image having colors determined by a total amount of the color materials that are applied per unit area, said image processing apparatus comprising:
means for determining a provisional total amount of color materials by adding an amount of said background color material represented by a certain value to the amounts of said process color materials per unit area which are represented by a device signal supplied to said image output device; and
total-amount-of-color-material adjusting means for reducing said provisional total amount of color materials so that the total amount of color materials is equal to or lower than a total-amount-of-color-material upper limit for said image output device.

7. An image processing apparatus according to claim 6, wherein said base comprises a transparent base, and said image output device comprises an ink jet printer or an electrophotographic printer.

8. A CPU-readable recording medium storing therein a program executable by a CPU, applicable to an image output device for forming on a base a color image with a background color material and process color materials, said color image having colors determined by the total amount of the color materials that are added per unit area, said program enabling said CPU to perform:
a step of determining a provisional total amount of color materials by adding an amount of said background color material represented by a certain value to the amounts of said process color materials per unit area which are represented by a device signal supplied to said image output device; and
a total-amount-of-color-material adjusting step of reducing said provisional total amount of color materials so that the total amount of color materials is equal to or lower than a total-amount-of-color-material upper limit for said image output device.
